(19) United States
(12) Patent Application Publication
(10) Pub. No.: US 2024/0184856 A1
(43) Pub. Date: Jun. 6, 2024

(54) METHOD AND KIT FOR RECOGNISING A USER OF A FOOTWEAR ARTICLE OR AN ACTIVITY PERFORMED BY A USER OF A FOOTWEAR ARTICLE

(71) Applicant: Zhor Tech, Nancy (FR)

(72) Inventors: Karim OUMNIA, Nancy (FR); Radouane OUDRHIRI, Nancy (FR)

(21) Appl. No.: 18/285,843

(22) PCT Filed: Apr. 6, 2022
(86) PCT No.: PCT/EP22/59073

§ 371 Date: Feb. 9, 2024

(30) Foreign Application Priority Data
Apr. 6, 2021 (FR) FR2103524

(51) Int. Cl. G06F 18/2415; G06N 3/0895

(52) U.S. Cl. CPC G06F 18/2415; G06N 3/0895

(57) ABSTRACT

The invention relates to the field involving the performance of activities. In particular, the invention relates to a method and kit for recognising a user of a footwear article or an activity performed by a user of a footwear article. One of the objectives of the invention is to facilitate the detection of a user of a footwear article or of an activity performed by a user of a footwear article. For this purpose, the inventors propose the use of raw sensor data from the footwear article, which data is supplied to a machine-learning-trained classifier. The inventors have discovered that the use of raw sensor data, without fusion, by a classifier allows surprisingly good results to be obtained in the recognition of a subject or of different activities performed by a subject. In particular, the invention uses the embedding technique to project the raw data in a data representation space that is suitable for the desired classification.

### TECHNICAL FIELD

The invention relates to the field of practicing activities. Particularly, it concerns a method and a kit for recognizing a subject or the different activities practiced by a subject.

### PRIOR ART

A high level of an activity is beneficial to the maintenance of health.

Indeed, it is known that it is possible to obtain the beneficial effects of an activity not only through high exercise intensity, but also through moderate, repeated and prolonged effort.

However, given the heterogeneity of the activities that can be practiced by a user of footwear, it seems difficult to assess the duration and intensity of all the activities practiced by a subject.

Moreover, if several subjects use the footwear, it seems difficult to identify each of them in order to associate them with the activities they are practicing.

There is therefore a need to objectively identify the different activities practiced by a subject as well as the different subjects using footwear.

### SUMMARY OF THE INVENTION

The invention aims to at least partially overcome this need.

Thus, the invention concerns a method for recognizing a footwear user or an activity practiced by a footwear user.

Particularly, the footwear comprises a pair of shoes and at least two sensors positioned on or in the pair of shoes so as to generate a raw sensor data stream in response to at least one biomechanical movement of the user during the practice of an activity.

Furthermore, the method comprises:
a step of receiving a raw sensor data stream,
a step of projecting at least one segment of the raw sensor data stream into an embedding space so as to obtain a representation vector having a predetermined size and reduced compared to the dimension of the raw sensor data received, and
a step of classifying the raw sensor data received from the representation vector and a classifier trained by machine learning to provide a prediction of whether the segment of the raw sensor data stream belongs to a class of user or to a class of activity practiced by the user.

In a first embodiment, the projection step comprises the use of a bidirectional recurrent neural network (RNN) trained to generate a representation vector from raw sensor data.

In an example of the first embodiment, the bidirectional recurrent neural network, RNN, is a bidirectional long short-term memory (LSTM) network that uses a triplet loss function.

In a second embodiment, the embedding space is a user embedding space and the representation vector is a user representation vector.

In a third embodiment, the embedding space is an activity embedding space and the representation vector is an activity representation vector.

In a fourth embodiment, the classifier trained by machine learning comprises a random forest classifier or a regression-based classifier.

In a fifth embodiment, the raw data comprise at least one type of data chosen from: force sensor data, gyroscope sensor data, gyrometer sensor data, accelerometer sensor data.

In a sixth embodiment, each segment of the raw sensor data stream has a temporal duration of at least 500 ms, preferably 1 second.

In an eighth embodiment, the footwear comprises at least one processor and the method is carried out by the processor.

In a ninth embodiment, the footwear comprises at least one wireless connection module and the method is carried out by a Smartphone or a cloud computing connected wirelessly with the wireless connection module.

The invention also relates to a kit which comprises:
at least one sensor adapted to be positioned on or in footwear comprising a pair of shoes so as to generate a raw sensor data stream in response to at least one biomechanical movement of the user during the practice of an activity, the raw sensor data comprising a plurality of types of data representative of a movement of a foot of the user,
at least one processor configured to execute a process, and
at least one memory configured to store the process executable by the processor, the process, when executed, being configured to:
receive a raw sensor data stream,
project at least one segment of the raw sensor data stream into an embedding space so as to obtain a representation vector having a predetermined and reduced size compared to the dimension of the raw sensor data received,
classify the raw sensor data received from the representation vector and a classifier trained by machine learning to provide a prediction of whether the segment of the raw sensor data stream belongs to a class of user or to a class of activity practiced by the user.

In a first embodiment, the processor is disposed at least partially inside the footwear.

In a second embodiment, the footwear further comprises at least one wireless connection module,
and in which the processor is comprised in a device connected wirelessly with the wireless connection module and chosen from: a Smartphone or a cloud computing.

### BRIEF DESCRIPTION OF THE DRAWINGS

Other characteristics and advantages of the invention will be better understood upon reading the following description and with reference to the appended drawings, given by way of illustration and without limitation.

FIG. 1 represents a method for recognizing a subject or the different activities practiced by a subject, according to the invention.

FIG. 2 represents an example of implementation of the method of [FIG. 1].

FIG. 3 represents a kit according to the invention.

The FIGURES do not necessarily meet the scales, in particular in thickness, for purposes of illustration.

### DESCRIPTION OF THE EMBODIMENTS

One of the objectives of this invention is to facilitate the detection of a footwear user or of an activity practiced by a footwear user.

By “footwear”, it is meant within the meaning of the invention, a pair for example of shoes, each shoe being intended for one foot of the user.

To do so, the inventors propose using raw sensor data from the footwear provided to a classifier trained by machine learning.

Indeed, the inventors discovered that the use of raw sensor data, without fusion, by a classifier makes it possible to obtain surprisingly efficient results in the recognition of a subject or of the different activities practiced by a subject.

Particularly, the invention uses the method called “embedding” method to project the raw data into a data representation space which is adapted for the desired classification.

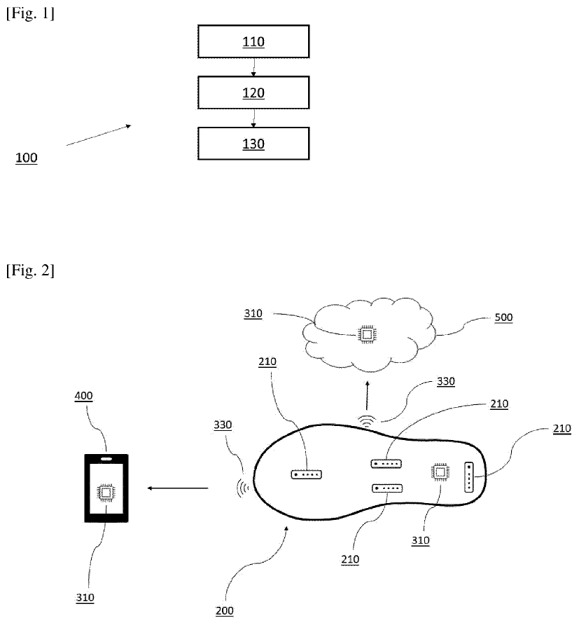

Thus, as illustrated in [FIG. 1], the invention relates to a method 100 for recognizing a subject or the different activities practiced by a subject.

In an example, the activity is chosen from: football, basketball, ping-pong, badminton, walking, running.

However, the activity may concern other disciplines that require the use of footwear, without requiring substantial modifications to the invention.

In the invention, the footwear comprises a pair of shoes.

In a particular implementation, the footwear can comprise a pair of insoles.

FIG. 2 illustrates footwear which comprises an insole 200.

In the following examples, when the different hardware components are described in relation to the insole of the footwear, these are non-limiting embodiments and it is provided that the different hardware components can be disposed in other parts of the footwear.

Advantageously, the method 100 is implemented from a raw data stream from one or several sensors positioned on or in a pair of shoes, for example at least partly in a sole. However, the present invention in these different embodiments, preferred or not, could be applied in the case where the sensors are not integrated into a sole. It could particularly be applied when the sensor(s) are positioned on a shoe, for example at the level of the tongue, of the upper or of the counter of a shoe.

In a first particular embodiment of the invention, the insole 200 comprises at least one processor 310.

Thus, in this first particular embodiment of the invention, the processor 310 carries out the method 100.

In a second embodiment of the invention, the insole 200 comprises at least one wireless connection module 330.

Thus, in this second particular embodiment of the invention, the method 100 is implemented by a remote device.

In a first example, a Smartphone 400 connected wirelessly with the wireless connection module 330 carries out the method 100.

In a second example, a cloud computing 500 connected wirelessly with the wireless connection module 330 carries out the method 100.

Moreover, in the invention, each insole 200 comprises at least one sensor 210. Preferably, each insole 200 comprises at least two sensors 210. Indeed, the use of several sensors on or in each of the shoes coupled with the use of a representation vector having a predetermined size makes it possible to improve the recognition.

In a first example, the sensor 210 is a force sensor.

In a second example, the sensor 210 is a single-axis or multi-axis of movement gyroscope sensor.

In a third example, the sensor 210 is a single-axis or multi-axis of movement gyrometer sensor.

In a fourth example, the sensor 210 is a single-axis or multi-axis accelerometer sensor.

In practice, the sensor 210 is disposed at least partially inside the insole 200. The insole 200 can correspond to a removable sole or to a midsole.

In this way, the sensor 210 is configured to generate a raw sensor data stream in response to at least one biomechanical movement of the user during the practice of an activity.

By “biomechanical movement”, it is meant within the meaning of the invention a characteristic of the posture or mobility of the user, which can in particular be determined at a key moment of a cycle and therefore be more complex to determine. A cycle could for example be a walk cycle. There are different types of activities such as the step, climb of a step, descent of a step, stride, jump, flat, static state, trample, kneeling . . . Therefore, a cycle can also correspond to a plurality of activities of different types depending on the complexity of the movement carried out by the user.

Particularly, the raw sensor data stream comprises a plurality of types of data representative of a movement of a foot of the user.

In one example, the raw sensor data comprise at least one type of data chosen from: force sensor data, gyroscope sensor data, gyrometer sensor data, accelerometer sensor data.

In another example, the raw sensor data are sampled at a predetermined frequency greater than 50 Hz, preferably greater than or equal to 100 Hz.

In the invention, the method 100 firstly comprises a step 110 of receiving a raw sensor data stream.

In practice, the raw sensor data stream is received as a function of time during the practice of an activity by a user of the footwear.

Particularly, the raw sensor data stream comprises a plurality of segments.

In one example, each segment of the raw sensor data stream has a temporal duration of at least 100 ms, at least 500 ms, preferably one second. Preferably, each segment of the raw sensor data stream has a temporal duration of at most ten seconds, preferably at most 5 seconds.

Then, the method 100 comprises a step 120 of projecting at least one segment of the raw sensor data stream into an embedding space (embedding method) so as to obtain a representation vector which has a predetermined and reduced size compared to the dimension of the raw sensor data received.

By “embedding space”, it is meant the projection of a vector (often large vector) which represents a categorical variable (e.g. a user or an activity practiced by a user) into a new space of controlled size which models the relationships between the different categories.

In a first example, the embedding space is a user embedding space and the representation vector is a user representation vector.

Thus, in the first example, it is considered that the raw sensor data can be associated with a user.

In a second example, the embedding space is an activity embedding space and the representation vector is an activity representation vector.

Thus, in the second example, it is considered that the raw sensor data can be associated with an activity practiced by a user.

In a third example, the embedding space is a common user and activity embedding space and the representation vector is a common user and activity representation vector.

Thus, in the third example, it is considered that the raw sensor data can be associated with a user and an activity practiced by a user.

In practice, the projection step 120 comprises the use of a bidirectional recurrent neural network (RNN) trained to generate a representation vector from raw sensor data.

In an example, the bidirectional recurrent neural network (RNN) is trained without non-linear hidden layer. Thus, the matrix of the weights of the linear layer can be interpreted as a linear projection which makes it possible to move from the space of the raw sensor data to a space of reduced dimension.

In a particular implementation, the bidirectional recurrent neural network, RNN, is a bidirectional long short-term memory, LSTM, network which uses a triplet loss function.

As a reminder, a triplet loss function during the training of the learning model is used. In this case, instead of taking two entries, as is commonly the case, three entries called the anchor, the positive and the negative will be taken. The anchor will be the reference entry, the positive will be an entry that has the same class as the anchor, while the negative must be an entry with a different class than the anchor.

In a first example, in the case of recognition of a footwear user according to the invention, the anchor can be a first raw sensor data vector associated with a first footwear user, the positive can be a second raw sensor data vector associated with the first user of the footwear and the negative can be a third raw sensor data vector associated with another user of the footwear.

In a second example, in the case of recognition of an activity practiced by a footwear user according to the invention, the anchor can be a first raw sensor data vector associated with a first activity practiced by a footwear user, the positive can be a second raw sensor data vector associated with the first activity practiced by the user of the footwear and the negative can be a third raw sensor data vector associated with another activity practiced by the user of the footwear.

Finally, the method 100 comprises a step of classifying 130 the raw sensor data received from the representation vector and a classifier trained by machine learning to provide a prediction of whether the segment of the raw sensor data stream belongs to a class of user or to a class of activity practiced by the user.

In a first particular embodiment of the invention, the classifier trained by machine learning comprises a random forest classifier or a regression-based classifier (for example linear, logistic regression, etc.).

In a second particular embodiment of the invention, the classifier trained by machine learning is obtained by supervised training on a set of training data previously collected for a plurality of predetermined activities. Particularly, the training data set comprises raw sensor data.

In a first example, 70% of the training data set is used to train the classifier and 30% of the training data set is used to test the classifier thus trained.

However, another distribution of the training data set could be used, without requiring substantial modifications to the invention.

In a second example, the training data set comprises raw sensor data which have been acquired during a predetermined time interval, for example less than 1 minute, 30 seconds, 10 seconds or the like.

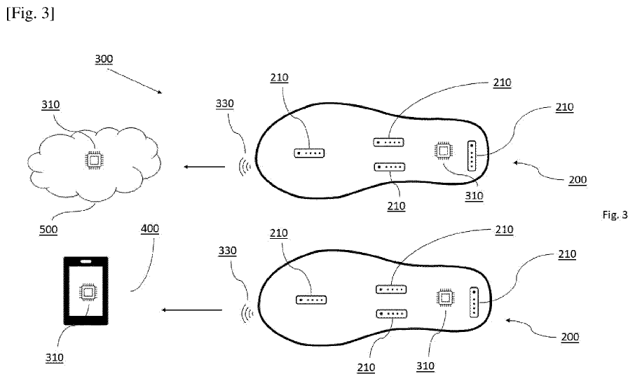

The invention also relates to a kit 300 as illustrated in [FIG. 3].

In the invention, the kit 300 comprises at least one sensor 210, at least one processor 310 and at least one memory 320.

The sensor 210 is adapted to be positioned on or in footwear comprising a pair of shoes so as to generate a raw sensor data stream in response to at least one biomechanical movement of the user during the practice of an activity, the raw sensor data comprising a plurality of types of data representative of a movement of a foot of the user.

Preferably, the kit 300 comprises at least four sensors 210, at least two sensors being positioned on or in each of the shoes.

The processor 310 is configured to execute a process.

The memory 320 is configured to store the process executable by the processor 310.

In a particular implementation, the kit 300 can also comprise a pair of insoles 200.

In this particular implementation, the pair of soles is configured to be inserted into footwear.

Moreover, the process, when executed, is configured to:
receive a raw sensor data stream,
project at least one segment of the raw sensor data stream into an embedding space so as to obtain a representation vector having a predetermined and reduced size compared to the dimension of the raw sensor data received,
classify the raw sensor data received from the representation vector and a classifier trained by machine learning to provide a prediction of whether the segment of the raw sensor data stream belongs to a class of user or to a class of activity practiced by the user.

In a first particular embodiment of the invention, the processor 310 is disposed at least partially inside the footwear.

In one example, the processor is disposed at least partially inside the insole 200.

In a second particular embodiment of the invention, the footwear further comprises at least one wireless connection module 330.

Thus, in this second particular embodiment of the invention, the processor 310 is comprised in a device connected wirelessly to the wireless connection module 330 and chosen from: a Smartphone 400 or a cloud computing 500.

The invention has been described and illustrated. However, the invention is not limited to the embodiments that have been presented. Thus, an expert in the field can deduce other variants and embodiments, upon reading the description and the appended FIGURES.

The invention can be the subject of numerous variants and applications other than those described above. Particularly, unless otherwise specified, the different structural and functional characteristics of each of the implementations described above should not be considered as combined and/or closely and/or inextricably linked to each other, but on the contrary as simple juxtapositions. Furthermore, the structural and/or functional characteristics of the different embodiments described above may be subject in whole or in part to any different juxtaposition or to any different combination.

1. A computer-implemented method for recognizing a footwear user or an activity practiced by a footwear user, the footwear including a pair of shoes and at least two sensors positioned respectively on or in the pair of shoes, the method comprising:
a step of receiving a raw sensor data stream from the at least two sensors, the raw sensor data stream comprising a plurality of types of data representative of a movement of a foot of the user,
a step of projecting at least one segment of the raw sensor data stream into an embedding space so as to obtain a representation vector having a predetermined size and being reduced compared to a dimension of the raw sensor data stream received, and
a step of classifying the raw sensor data stream received from the representation vector and a classifier trained by machine learning, to provide a prediction of whether the at least one segment of the raw sensor data stream belongs to a class of user or to a class of activity practiced by the user.

2. The computer-implemented method according to claim 1, wherein the projection step comprises using a bidirectional recurrent neural network, RNN, trained to generate the representation vector from the raw sensor data stream.

3. The computer-implemented method according to claim 2, wherein the bidirectional recurrent neural network, RNN, is a bidirectional long short-term memory, LSTM, network that uses a triplet loss function.

4. The computer-implemented method according to claim 1, wherein, the embedding space is a user embedding space and the representation vector is a user representation vector.

5. The computer-implemented method according to claim 1, wherein the embedding space is an activity embedding space and the representation vector is an activity representation vector.

6. The computer-implemented method according to claim 1, wherein the classifier trained by machine learning comprises a random forest classifier or a regression-based classifier.

7. The computer-implemented method according to claim 1, wherein the raw data stream comprises at least one type of data chosen from: force sensor data, gyroscope sensor data, gyrometer sensor data, accelerometer sensor data.

8. The computer-implemented method according to claim 1, wherein each segment of the raw sensor data stream has a temporal duration of at least 500 ms.

9. The computer-implemented method according to claim 1, wherein the footwear comprises at least one processor, the method being carried out by the processor.

10. The computer-implemented method according to claim 1, wherein the footwear comprises at least one wireless connection module, the method being carried out by a smartphone or a cloud computing connected wirelessly with the wireless connection module.

11. A kit comprising:
at least two sensors adapted to be positioned on or in footwear comprising a pair of shoes so as to generate a raw sensor data stream in response to at least one biomechanical movement of the user during practice of an activity,
a processor configured to execute a process, and
a memory configured to store the process executable by the processor, the process, when executed, being configured to:
receive a raw sensor data stream, the raw sensor data stream comprising a plurality of types of data representative of a movement of a foot of the user,
project at least one segment of the raw sensor data stream into an embedding space, so as to obtain a representation vector having a predetermined and reduced size compared to a dimension of the raw sensor data received, and
classify the raw sensor data received from the representation vector and a classifier trained by machine learning, to provide a prediction of whether the at least one segment of the raw sensor data stream belongs to a class of user or to a class of activity practiced by the user.

12. The kit according to claim 11, wherein the processor is disposed at least partially inside the footwear.

13. The kit according to claim 11, wherein the footwear further comprises at least one wireless connection module, and wherein the processor is comprised in a device connected wirelessly with the wireless connection module and chosen from: a smartphone or a cloud computing.

14. The computer-implemented method according to claim 1, said temporal duration being at least 1 second.
